(19) United States
(12) Patent Application Publication
(10) Pub. No.: US 2026/0045132 A1
(43) Pub. Date: Feb. 12, 2026

(54) LOTTERY TICKET VENDING MACHINE WITH TICKET BURSTER PRE-POSITIONING FEATURE

(71) Applicant: Brightstar Global Solutions Corporation, Providence, RI (US)

(72) Inventors: Apostolos D. Kallis, Barrington, RI (US); Raymond S. Leland, Warwick, RI (US)

(21) Appl. No.: 18/799,329

(22) Filed: Aug. 9, 2024

(51) Int. Cl. G07C 15/00

(52) U.S. Cl. CPC G07C 15/005; G07C 15/006

(57) ABSTRACT

A lottery ticket vending machine that includes a ticket burster and a plurality of ticket drawers configured to hold different instant lottery ticket packs for different instant ticket lottery games, wherein the lottery ticket vending machine is configured to move the ticket burster to a pre-purchase position that is close to the lottery ticket drawer that holds an instant lottery ticket that is predicted to be the subsequently purchased instant lottery ticket from the lottery ticket vending machine to try to reduce the amount of time needed to complete the movement of the burster to the respective ticket drawer that holds that instant lottery ticket and thus to dispense that instant lottery ticket.

### BACKGROUND

The present disclosure relates to lottery ticket vending machines with a ticket burster pre-positioning feature.

Lottery tickets such as instant lottery tickets may be printed on a strip that may be fan-folded and provided as a pack of lottery tickets. Lottery tickets in such strips may be separated along perforations formed between adjacent tickets in the strips. Lottery tickets may vary in width and length. Lottery tickets may be sold from such packs using lottery ticket vending machines. A lottery ticket vending machine may include multiple ticket drawers that hold the lottery tickets and a movable ticket burster that moves to a particular ticket drawer to dispense a purchased lottery ticket.

### BRIEF SUMMARY

In various embodiments, the present disclosure relates to a lottery ticket vending machine including: a housing; a ticket drawer holder in the housing, the ticket drawer holder having a plurality of ticket drawers, each of the ticket drawers configured to hold a pack of instant lottery tickets for one of a plurality of different instant lottery ticket games; a ticket receptacle supported by the housing; and a ticket burster in the housing. The ticket burster is movable to a plurality of different ticket receipt positions, each different ticket receipt position associated with and in alignment with a different one of the plurality of ticket drawers. In each ticket receipt position, the ticket burster is configured to receive from the ticket drawer associated with that ticket receipt position an instant lottery ticket attached to a next instant lottery ticket, separate the instant lottery ticket from the next instant lottery ticket, and dispense the instant lottery ticket into the ticket receptacle. The lottery ticket vending machine also includes a controller including a processor and memory device that stores a plurality of instructions, which when executed by the processor cause the processor to: determine lottery ticket purchase data that associated with prior lottery ticket purchases for the plurality of different instant lottery ticket games; responsive to an occurrence of a pre-positioning event, predict one of the lottery tickets in one of the ticket drawers to be a subsequent lottery ticket to be purchased from the lottery ticket vending machine based on the lottery ticket purchase data; determine a pre-purchase position for the ticket burster based on the predicted lottery ticket and the ticket drawer that the predicted lottery ticket is held; and cause the ticket burster to move to the pre-purchase position.

In various other embodiments, the present disclosure relates to a lottery ticket vending machine including: a housing; a plurality of ticket drawers in the housing, each of the ticket drawers configured to hold a pack of instant lottery tickets for one of a plurality of different instant lottery ticket games; and a ticket burster the housing. The ticket burster is movable to a plurality of different ticket receipt positions, each different ticket receipt position associated with and in alignment with a different one of the plurality of ticket drawers. The lottery ticket vending machine also includes a controller including a processor and memory device that stores a plurality of instructions, which when executed by the processor cause the processor to: determine a pre-purchase position for the ticket burster based on a predicted one of the instant lottery tickets for a subsequent purchase from the lottery ticket vending machine and the ticket drawer that the predicted one of instant lottery tickets is held, and cause the ticket burster to move to the pre-purchase position.

In various other embodiments, the present disclosure relates to a lottery ticket vending machine including: a housing; a first plurality of ticket drawers in the housing, each of the first ticket drawers configured to hold a pack of instant lottery tickets for one of a first plurality of different instant lottery ticket games; a second plurality of ticket drawers in the housing, each of the second ticket drawers configured to hold a pack of instant lottery tickets for one of a second plurality of different instant lottery ticket games; first ticket burster in the housing, the first ticket burster movable to a first plurality of different ticket receipt positions, each different ticket receipt position associated with and in alignment with a different one of the first plurality of ticket drawers; and a second ticket burster in the housing, the second ticket burster movable to a second plurality of different ticket receipt positions, each different ticket receipt position associated with and in alignment with a different one of the second plurality of ticket drawers. The lottery ticket vending machine also includes a controller including a processor and memory device that stores a plurality of instructions, which when executed by the processor cause the processor to: determine a first pre-purchase position for the first ticket burster based on a first predicted one of the instant lottery tickets for a subsequent purchase from the lottery ticket vending machine and the ticket drawer of the first plurality of ticket drawers that the first predicted one of instant lottery tickets is held, cause the first ticket burster to move to the first pre-purchase position, determine a second pre-purchase position for the second ticket burster based on a second predicted one of the instant lottery tickets for a subsequent purchase from the lottery ticket vending machine and the ticket drawer of the second plurality of ticket drawers that the second predicted one of instant lottery tickets is held, and cause the second ticket burster to move to the second pre-purchase position.

Additional features are described in, and will be apparent from, the following Detailed Description and the figures.

### BRIEF DESCRIPTION OF THE SEVERAL VIEWS OF THE DRAWINGS

FIG. 1 is a front perspective view of a lottery ticket vending machine of one example embodiment of the present disclosure shown with a front door thereof in a closed position.

FIG. 2 is a front perspective view of the lottery ticket vending machine of FIG. 1 shown with the front door thereof in an open position, shown with a left side wall panel thereof removed, showing three ticket drawer holders and three movable ticket bursters respectively associated with the three ticket drawer holders, and showing a ticket collection receptacle of the front door.

FIG. 3 is a front view of the lottery ticket vending machine of FIG. 1 shown with the front door thereof in the open position, shown with the left side wall panel thereof removed, showing the three ticket drawer holders and the three movable ticket bursters respectively associated the three ticket drawer holders, and showing the ticket collection receptacle of the front door.

FIG. 4 is an enlarged fragmentary perspective view of one of the ticket drawer holders and the ticket burster associated with that ticket drawer holder of the lottery ticket vending machine of FIG. 1 shown removed from the lottery ticket vending machine.

FIG. 5 is an enlarged fragmentary perspective view of the ticket drawer holder and the ticket burster of FIG. 4.

FIG. 6 is another enlarged fragmentary perspective view of the ticket drawer holder and the ticket burster of FIG. 4.

FIG. 7 is an enlarged fragmentary side view of the ticket drawer holder and the ticket burster of FIG. 4.

FIG. 8 is a flow chart of an example method operating a lottery ticket vending machine of FIG. 1 that includes the pre-positioning of a ticket burster of the lottery ticket vending machine in accordance with one example embodiments of the present disclosure.

FIG. 9 is a block diagram of a system for providing pre-positioning of a ticket burster in accordance with an alternative embodiment of the present disclosure.

### DETAILED DESCRIPTION

In various embodiments, the present disclosure relates to a lottery ticket vending machine that includes one or more ticket bursters and a plurality of ticket drawers. The ticket drawers are configured to hold different instant lottery ticket packs for different lottery games. Generally, responsive to each purchase request for one of the instant lottery tickets in one of the ticket drawers, the lottery ticket vending machine causes the respective ticket burster to move into a position in alignment with the ticket drawer that holds the requested instant lottery ticket, receive the requested instant lottery ticket from that ticket drawer, separate that requested instant lottery ticket from the attached next instant lottery ticket in that ticket drawer, and dispense the requested instant lottery ticket.

In various embodiments, the lottery ticket vending machine is configured to move one of the ticket bursters thereof to a pre-purchase position that is close to the lottery ticket drawer that holds an instant lottery ticket that is predicted to be the subsequent purchased instant lottery ticket from the lottery ticket vending machine. After the ticket burster has been moved to the pre-purchase position, if the predicted instant lottery ticket is the subsequent instant lottery ticket purchased from the vending machine, the amount of time needed to complete the movement of the burster to the respective ticket drawer that holds that instant lottery ticket and thus to dispense that instant lottery ticket is reduced. The ticket purchaser of that instant lottery ticket has less time to wait before physically receiving the purchased instant lottery ticket.

After the ticket burster has been moved to the pre-purchase position, if the predicted instant lottery ticket is not the subsequent instant lottery ticket purchased from the vending machine, the amount of time needed to complete the movement of the burster to the respective ticket drawer that holds that instant lottery ticket and thus to dispense that instant lottery ticket is expected to be approximately the same as would be if the burster was not moved to the pred-purchase position (based on a general random distribution of purchases).

In various embodiments, the lottery ticket vending machine is configured to move multiple ticket bursters of the lottery ticket vending machine to respective pre-purchase positions that are respectively close to the lottery ticket drawers that holds multiple instant lottery tickets that are predicted to be the subsequent purchased instant lottery tickets from the lottery ticket vending machine.

In various embodiments, the lottery ticket vending machine is configured to makes such movement of the one or more ticket bursters thereof to the pre-purchase positions based on the locations of the ticket drawers, the instant lottery tickets in those ticket drawers, and lottery ticket purchase data such as but not limited to as described herein.

In various embodiments, the lottery ticket vending machine is configured to: (1) determine lottery ticket purchase data that is associated with prior lottery ticket purchases for a plurality of different instant lottery ticket games; (2) responsive to an occurrence of a pre-positioning event, predict an instant lottery ticket to be the subsequent instant lottery ticket to be purchased from the lottery ticket vending machine based on the lottery ticket purchase data; (3) determine a pre-purchase position for a ticket burster based on the predicted instant lottery ticket; and (4) cause the ticket burster to move to the pre-purchase position.

In various embodiments, the lottery ticket vending machine determines the pre-purchase position as a ticket receipt position associated with a ticket drawer that holds the predicted instant lottery ticket.

In various embodiments, the lottery ticket vending machine determines the pre-purchase position based on multiple ticket drawers holding multiple instant lottery tickets with a high volume of lottery ticket purchases.

In various embodiments, the lottery ticket vending machine is configured to track and store lottery ticket purchase data that includes for each of one or more instant lottery tickets a total quantity of the instant lottery ticket purchased in a period of time.

In various embodiments, the lottery ticket vending machine is configured to track and store lottery ticket purchase data that includes for each of one or more instant lottery tickets one or more of: (1) a timestamp associated with a lottery ticket purchase (e.g., a time of day and date); (2) a game and/or game type(s) of selected lottery ticket(s); (3) purchase parameters for the lottery ticket purchase; (4) purchaser information (e.g., a user identifier or rewards card identifier); and/or (5) other suitable information.

In various embodiments, the lottery ticket vending machine is configured to receive lottery ticket purchase data that includes for each of one or more instant lottery tickets a total quantity of the instant lottery ticket purchased in a period of time.

In various embodiments, the lottery ticket vending machine is configured to receive lottery ticket purchase data that includes one or more of: (1) a timestamp associated with a lottery ticket purchase (e.g., a time of day and date); (2) a game and/or game type(s) of selected lottery ticket(s); (3) purchase parameters for the lottery ticket purchase; (4) purchaser information (e.g., a user identifier or rewards card identifier); and/or (5) other suitable information.

For a better understanding of the present disclosure, example instant lottery tickets are first described.

Various known instant lottery tickets are single game instant lottery tickets. An example single game instant lottery ticket can include: (1) a ticket substrate having a front surface and a back surface; (2) a predefined scratch-off area on the front surface; (3) variable lottery game indicia printed on the predefined scratch-off area; (4) a scratch-off coating (“SOC”) covering the variable lottery game indicia and the predefined scratch-off area; and (5) variable instant lottery ticket information indicia printed on the back surface. The instant lottery ticket information indicia can include text, one or more ticket numbers, one or more ticket barcodes, and other instant lottery ticket information that is in human readable and machine readable forms. Certain of this instant lottery ticket information: (a) identifies the instant lottery ticket; (b) the set, run, and/or pack of instant lottery tickets that the instant lottery ticket is part of; and (c) other inventory control information.

Various lottery tickets are often arranged after manufacture (which includes after complete printing) in lottery ticket packs for storage, organization, sorting, picking, shipping to lottery ticket distributors or ticket retailers, and validation. Instant lottery ticket packs can include a plurality of lottery tickets (that are all of the same type, same size, and for the same game(s), and can be protected for storage and shipping by a transparent pack wrapping, such as transparent plastic wrapping, securely wrapped around the plurality of lottery tickets. A pack of lottery tickets can include all of the lottery tickets attached to each other but joined by perforations. Such lottery tickets of a pack can be detached from each other along such perforations. While lottery tickets of each pack are often manufactured in a continuous strip that is fan-folded for convenient supply, the packs can be in other forms such as in a roll form. These packs in the fan-folded form or in the roll form are configured to be dispensed via a lottery ticket vending machine.

To dispense such instant lottery ticket, lottery ticket vending machines can include various components such as but not limited to pinch rollers, stepper motors, and cutting blades to separate and dispense lottery tickets from a pack of lottery tickets, for example, within one or more ticket bursters. Various embodiments of the present disclosure provide a lottery ticket vending machine that determines for each of one, a plurality, or each of its ticket burster, a pre-purchase position for that ticket burster to actually or try to: (1) reduce a purchase time for a subsequently purchased lottery ticket; (2) reduce a burster travel time of that ticket burster when dispensing a subsequent lottery ticket; (3) reduce a burster travel distance of the ticket burster when dispensing the subsequent lottery ticket; (4) reduce burster travel maintenance; (5) increase a service interval of the ticket burster and/or other components of the lottery ticket vending machine; (6) increase a service lifespan of the ticket burster and/or other components of the lottery ticket vending machine; and/or (7) reduce burster travel energy expenditure.

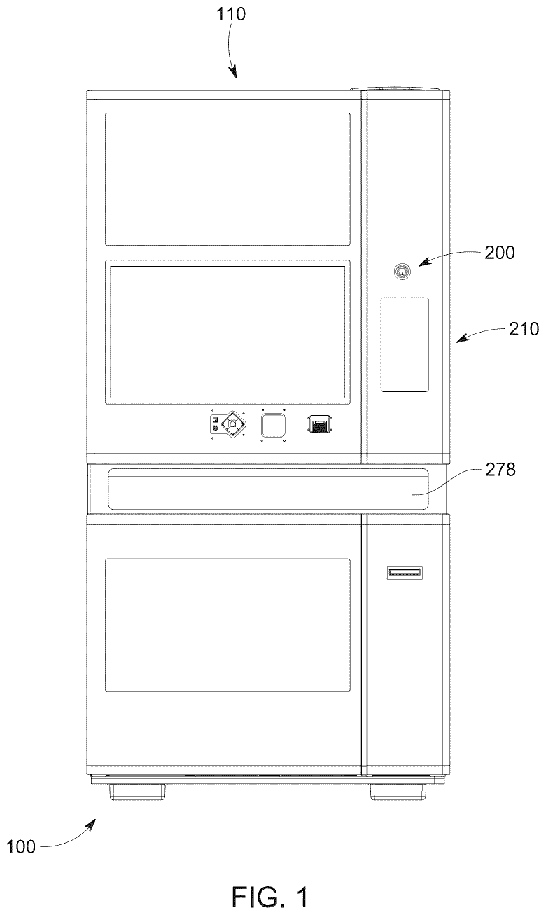

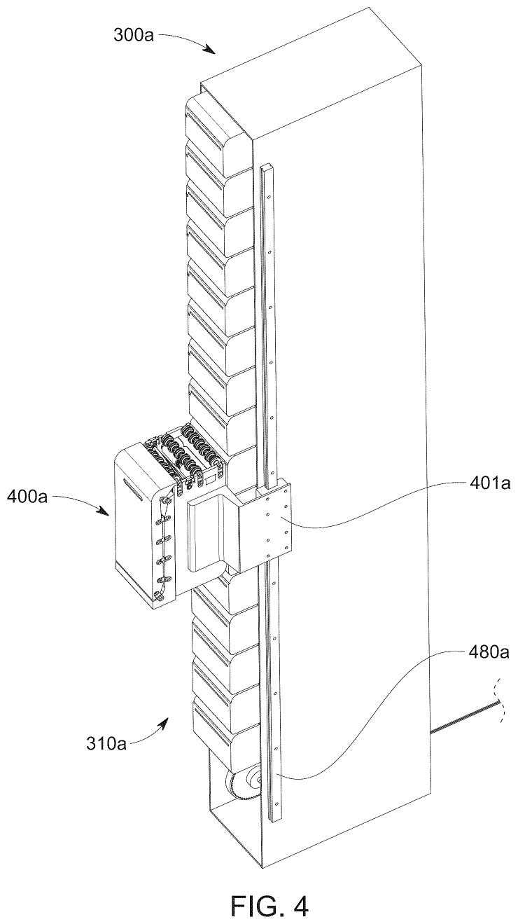

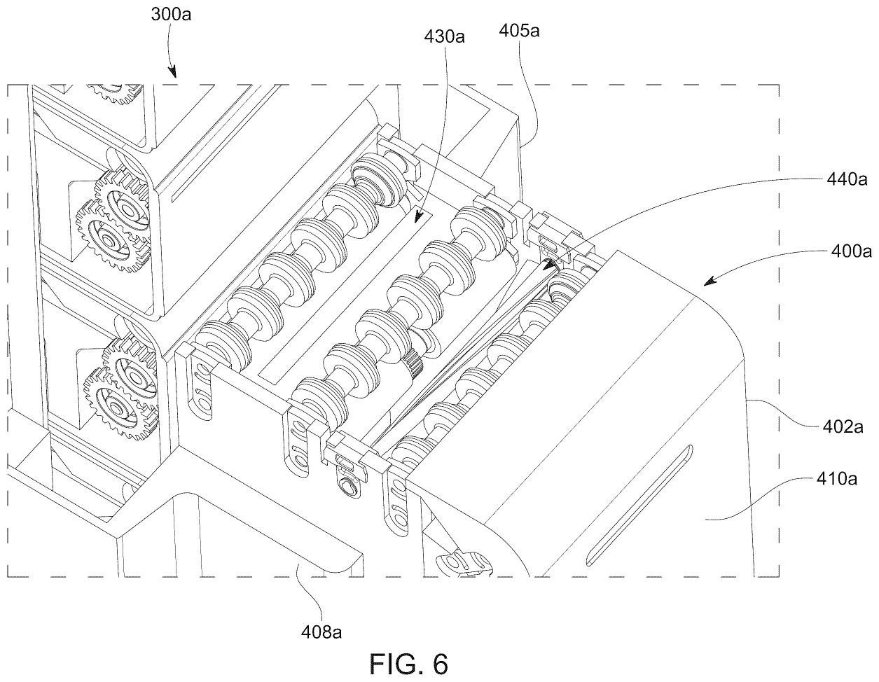

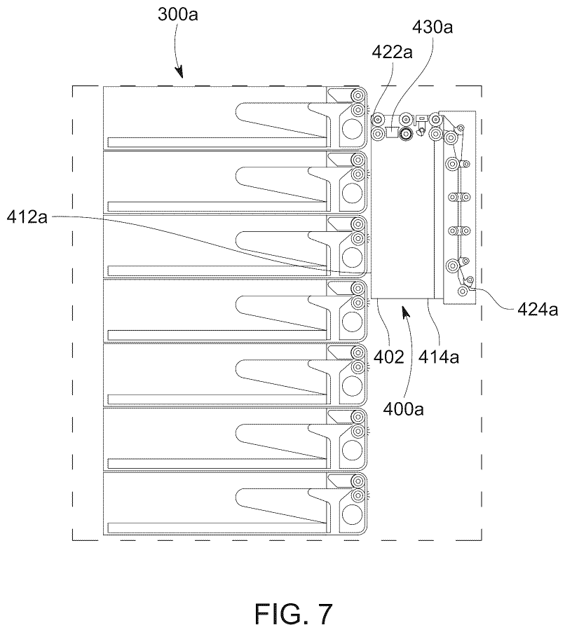

Turning now to FIGS. 1, 2, 3, 4, 5, 6, and 7, a lottery ticket vending machine of one example embodiment of the present disclosure is generally illustrated and indicated by numeral 100. The lottery ticket vending machine 100 may be referred to herein as the “ticket vending machine” or the “vending machine” for brevity. The lottery ticket vending machine can be configured in other manners in accordance with the present disclosure.

The illustrated example ticket vending machine 100 includes: (a) a machine housing 110 including a front door 200; (b) three ticket drawer holders 300a, 300b, and 300c positioned in and supported by the machine housing 110; and (c) three separate and independently movable ticket bursters 400a, 400b, and 400c positioned in the machine housing 110 and supported by burster supports (not labeled) positioned in and supported by the machine housing 110; and (d) a controller 500. The front door 200 includes a ticket collection receptacle 250 configured to receive separated lottery tickets from each of the ticket bursters 400a, 400b, and 400c. The quantity, positions, sizes, and configurations of the ticket drawer holders and the ticket bursters can vary in accordance with the present disclosure. In various embodiments, a front door of the ticket vending machine includes one or more ticket display windows that provide improved visibility of the ticket drawer holders 300a, 300b, and 300c and the ticket bursters 400a, 400b, and 400c.

It should be appreciated that the ticket vending machine 100 includes various other components that are conventional in the industry and/or that would be readily apparent to those of ordinary skill in the art. For example, the ticket vending machine 100 can include: (1) various electronic components (not shown) some of which can be contained in an electronic component holder (not labeled) positioned in and supported by the machine housing 110; and (2) various purchaser interface components 210 that are part of the front door 200 of the machine housing 110. These components are only briefly described herein for brevity. Such electronic components can be arranged in any suitable manner. The electronic component holder can be in the form of a slide-out drawer to facilitate access to the various electronic components contained therein. The electronic components can form part of the control system for the ticket vending machine 100. Various electronic components can also be positioned in the machine housing 110 outside of the electrical component holder. The electronic components can include one or more controllers that control the operation of the ticket vending machine 100 including the movable ticket bursters 400a, 400b, and 400c as further discussed herein to facilitate the dispensing of each requested lottery ticket and the determination of any position issues of the lottery tickets (such as further described below). The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the ticket vending machine 100. The purchaser interface components 210 include one or more display devices, one or more user input devices (e.g., buttons, keypads), and one or more payment acceptors. In various embodiments, the purchaser interface components 210 include a touch-screen display. The purchaser interface components 210 enable purchasers to use such components to determine the lottery tickets available from the ticket vending machine 100, and to select and pay for any of those lottery tickets held by the ticket vending machine 100 that the purchaser desires to obtain. The purchaser interface components 210 can display images and information to inform purchasers of the different lottery tickets available from the ticket vending machine 100 and to assist in completing the selection and purchase of such lottery tickets. These electronic components and purchaser interface components 210 can take many different forms as well known in the industry, and are thus not described in detail herein for brevity.

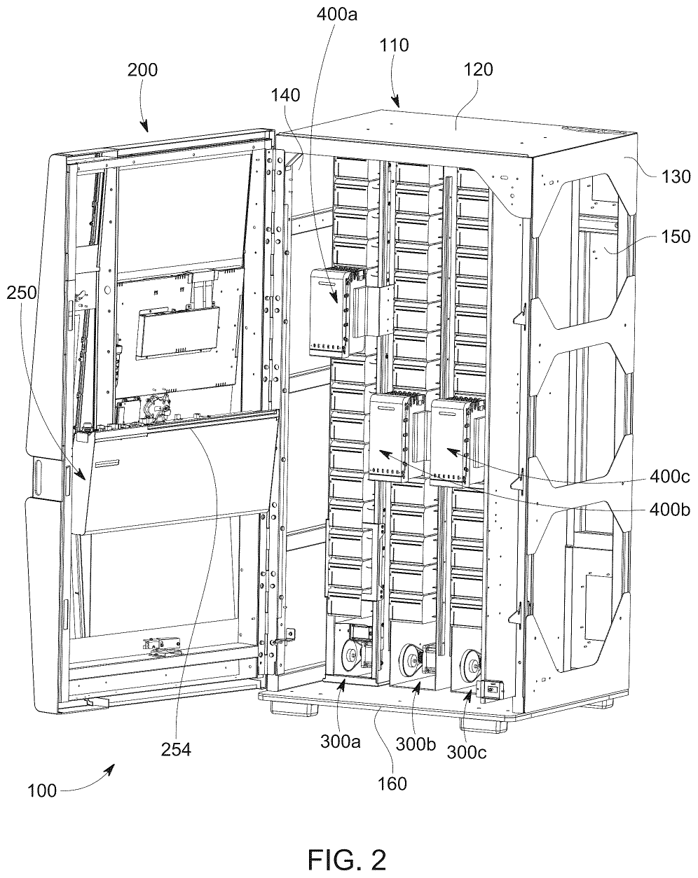

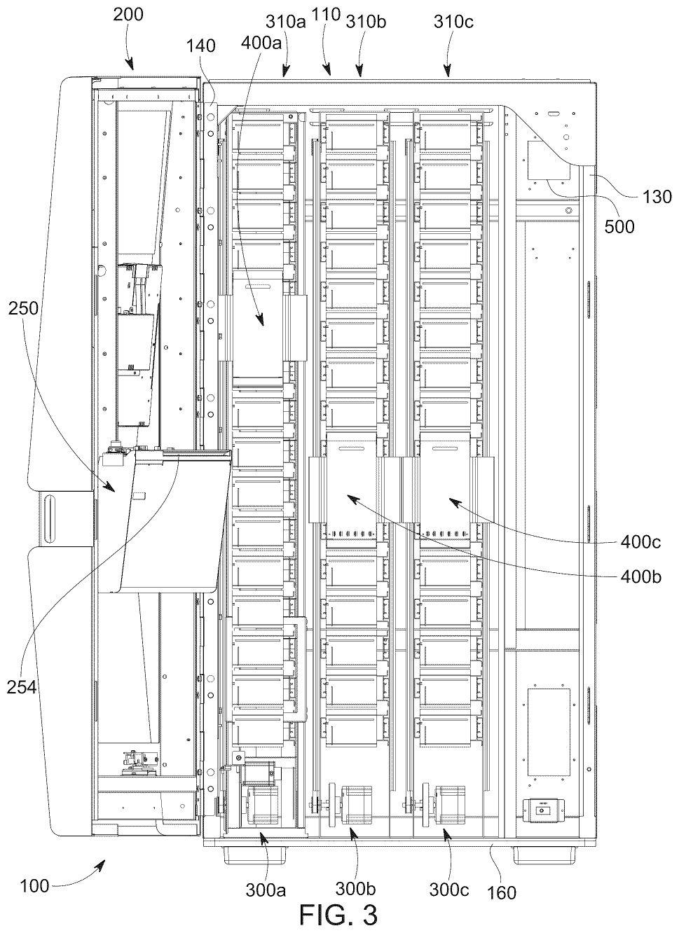

In this illustrated example embodiment, the machine housing 110 includes a top wall 120, spaced-apart side walls 130 and 140, a rear wall 150, a base 160, and the openable front door 200 pivotally connected to the side wall 140. The base 160 is configured to rest on a floor or other suitable support. The machine housing 110 includes suitable vertically extending supports (not labeled) configured to hold and support the respective ticket drawer holders 300a, 300b, and 300c. The front door 200 is moveable from a closed and locked position covering the open front face of the machine housing 110 as shown in FIG. 1 to an open position allowing access to the interior of the machine housing 110 as shown in FIGS. 2 and 3. The front door 200 is mounted by hinges (not labeled) to the side wall 140 of the machine housing 110. A suitable locking mechanism (not shown) is mounted on the front door 200 and the side wall 130 of the machine housing 110 to facilitate locking of the front door 200 in the closed position. When the front door 200 is closed and locked, the interior of the machine housing 110 is generally secured so as to be inaccessible except by an authorized person. The front door 200 can include one or more areas for any components supported by the front door and/or that are contained in and /r protected by the structure of the front door 200. The front door 200 can include one or more openings such as for a glass panel that enables people to see into the machine housing 110 and for one or more of the purchaser interface components 210 (such as those described below). The size and configuration of the machine housing can vary in accordance with the present disclosure.

The ticket collection receptacle 250 of the front door 200 is configured to receive lottery tickets from each of the movable ticket bursters 400a, 400b, and 400c. The ticket collection receptacle 250 is configured to hold each lottery ticket received from the movable ticket bursters to enable the respective purchaser to retrieve the dispensed lottery ticket from the ticket collection receptacle 250. The ticket collection receptacle defines an elongated horizontally extending ticket receiving slot 254 (best seen in FIGS. 2 and 3). The ticket collection receptacle 250 and the front door define an elongated horizontally extending purchase ticket retrieval slot 278 (best seen in FIG. 1). The purchase ticket retrieval slot 278 is (and needs to be) large enough so that a purchaser can insert the purchaser's hand through the purchase ticket retrieval slot 278 to retrieve lottery tickets that are dispensed into the ticket collection receptacle 250. The ticket receiving slot 254 is (and needs to be) small enough so that a purchaser cannot insert the purchaser's hand through the ticket receiving slot 254 and thereby cannot access any of the ticket drawers of the ticket drawer holders 300a, 300b, or 300c. The position, size, and configuration of the ticket collection receptacle can vary in accordance with the present disclosure.

Each of the ticket drawer holders 300a, 300b, and 300c are identical in this example embodiment. For brevity, only ticket drawer holder 300a is described in detail herein. Likewise, the three movable ticket bursters 400a, 400b, and 400c are identical in this example embodiment. For brevity, only ticket burster 400a associated with the ticket drawer holder 300a is described herein.

Ticket drawer holder 300a includes a plurality of aligned ticket drawers 310a that are vertically stacked in the holder. Each of the ticket drawers is configured to hold one or more packs of lottery tickets such as instant lottery tickets for subsequent dispensing by the ticket vending machine 100. The ticket drawers can vary in quantity, size, and configuration depending upon the particular size of the ticket vending machine 100 and the quantity, size, and shapes of the lottery tickets that the ticket vending machine 100 can or will dispense. Each ticket drawer is configured to hold lottery tickets such as instant lottery tickets for selection by the purchasers. In various embodiments, the different ticket drawers can hold different lottery ticket packs for different lottery games, but it should be appreciated, that two or more ticket drawers can hold the same type of lottery tickets, lottery tickets for the same game, etc. In various embodiments, each of the ticket drawers is configured to feed each instant lottery ticket held by that ticket drawer into the associated ticket burster 400a when the ticket burster 400a is moved into alignment with such ticket drawer (e.g., at a respective ticket receipt position) for receipt, bursting, and dispensing of that lottery ticket. This ticket movement can be caused by an actuation lever of the burster engaging a ticket movement assembly of the ticket drawer, or in another suitable manner. Bursting of the lottery ticket is the industry term for separating a lottery ticket from a pack of lottery tickets held in a ticket drawer. In this example embodiment, the ticket drawers do not burst the lottery tickets and do not need any mechanisms for bursting the lottery tickets, but rather the moveable ticket burster 400a bursts the lottery tickets fed by the ticket drawers in the ticket drawer holder 300a into that ticket burster 400a.

As shown in FIGS. 2, 3, and 4, the movable ticket burster 400a is supported by one or more burster supporters (such as burster supporter 480a). The burster supporters can be any suitable structure(s) that support(s) the ticket burster 400a in a manner that enables the ticket burster 400a to vertically move to any of the different ticket receipt positions that are associated with and in alignment with the respective ticket drawers of the ticket drawer holder 300a. Each of the burster supporters also support the ticket burster 400a in a manner that enables the ticket burster 400a to vertically move into alignment with the ticket receptacle 250.

In various embodiments, the burster supporter 480a can be any suitable structure that supports the ticket burster 400a and enables the ticket burster 400a to move to any of the different ticket receipt positions that are associated with and in alignment with the different respective ticket drawers 310 (e.g., ticket drawers 310a of the ticket drawer holder 300a, ticket drawers 310b of the ticket drawer holder 300b, and ticket drawers 310c of the ticket drawer holder 300c), and the ticket receptacle 250 if needed. For example, the burster supporter 480a can include a suitable XY gantry that supports the ticket burster 400a and enables the ticket burster 400a to move to any of these respective ticket receipt positions. In various such embodiments, the ticket vending machine 100 includes only one ticket burster 400a that is movable to any of the respective ticket receipt positions. In various such embodiments, the ticket vending machine 100 includes one active ticket burster and one or more inactive ticket bursters that are configured for use if the active ticket burster is unavailable (e.g., inoperable due to malfunction, removed for maintenance).

As can be seen from this example, the ticket vending machine 100 includes numerous ticket drawers, and to obtain any lottery ticket from any ticket drawer, the ticket burster may have to move a longer or shorter distance and such movement can take a longer or shorter amount of time depending on the starting position of the burster and the respective ticket drawer that holds the requested lottery ticket.

The ticket vending machine 100 includes one or more actuators (not shown) that control movement of the ticket burster 400a under control of the controller of the ticket vending machine 100 and/or the controller of the ticket burster 400a. In this example, an actuator (not labeled) is mounted at the bottom of the ticket drawer holder 300a and coupled to the ticket burster 400a by suitable linkages (such as but not limited to pulleys and a drive belt (not labeled)). The actuator is configured to move the ticket burster 400a under the control of the controller(s) in the vertical (e.g., up and down) directions. The movable ticket burster 400a is thus moveable, via this actuator and linkages on the ticket burster supporters to different vertical locations including a plurality of the locations respectively associated and aligned with each of the ticket drawers of the ticket drawer holder 300a such that the ticket burster 400a is positioned to receive one or more of the lottery tickets stored in each respective ticket drawer of the ticket drawer holder 300a for obtaining and dispensing that instant lottery ticket into the ticket receptacle 400 for the purchaser as requested by the purchaser. In various embodiments, the actuators are configured to move the ticket burster 400a under the control of the controller(s) in both the vertical (e.g., up and down) directions and horizontal (e.g., left and right) directions.

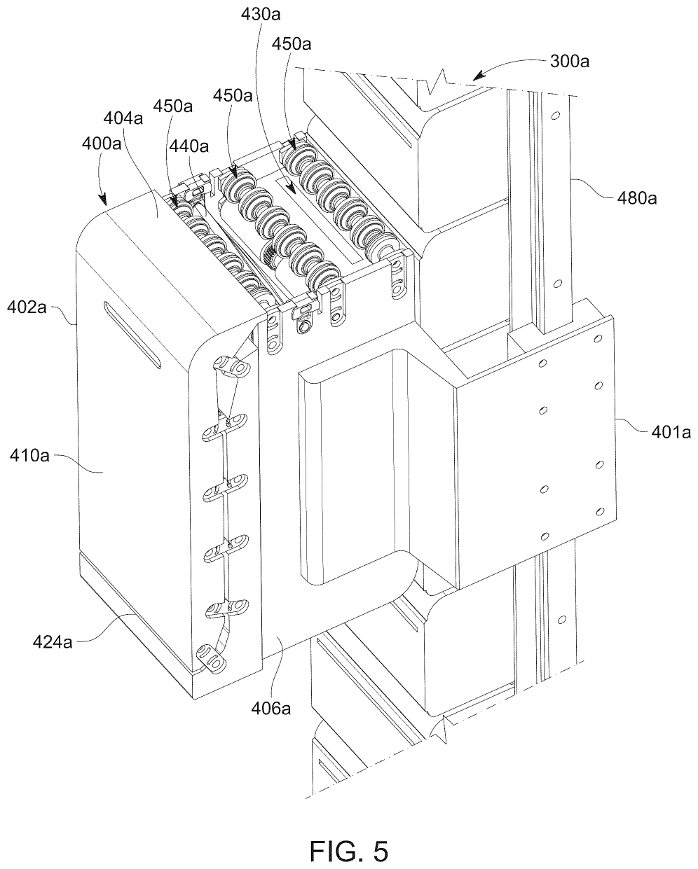

As best shown in FIGS. 5, 6, and 7, the example movable ticket burster 400a generally includes: (a) a burster housing 402a; (b) one or more burster supporter connecters such as burster support connector 401a connecting the burster housing 402a and the burster supporter 480a; (c) a barcode reader 430a in and supported by the burster housing 402a; (d) a ticket cutter 440a in and supported by the burster housing 42; (e) a plurality of ticket engagers 450a supported by the burster housing 402a; and (f) a burster controller (not shown). The size and configuration of the ticket burster can vary in accordance with the present disclosure. As indicated above, it should also be appreciated that in other embodiments, the ticket burster includes more than one barcode reader for determining barcode related data and barcode positional data. As also indicated above, it should also be appreciated that in other embodiments, the ticket burster includes one or more barcode readers for determining barcode related data.

More specifically, the burster housing 402a includes a top member 404a, spaced-apart side members (not labeled), a front member 410a, a rear member 412a, and a bottom member 414a. The burster housing 402a also includes a plurality of internal members (not individually labeled) that define a ticket inlet 422a, through which the ticket burster 400a is configured to receive a lottery ticket from a ticket drawer of the ticket drawer holder 300a, a ticket outlet 424a through which the ticket burster 400a is configured to dispense the received instant lottery ticket into the ticket collection receptacle 250, and a ticket movement path (not labeled) extending from the ticket inlet 422a to the ticket outlet 424a and through which the lottery ticket is moved through the ticket burster 400a.

The ticket cutter 440a is positioned in the burster housing 402a and configured to rotate to cut the perforations attaching each lottery ticket that moves along the ticket movement path in the ticket burster 400a to the next lottery ticket of the continuous strip of lottery tickets received from the respective ticket drawer.

In other embodiments, the ticket burster 400a can be configured such that the burster housing 402a is rotatable about a horizontal axis to separate (via a tearing and/or twisting motion) each lottery ticket along the perforations connecting that lottery ticket to the next lottery ticket in the strip. In such embodiments, the ticket drawer may not need to withdraw the next lottery ticket of the strip or may only need to withdraw the next lottery ticket of the strip a relatively small distance. In such embodiments, the ticket burster may not need a ticket cutter.

It should be appreciated that the ticket burster 400a is thus configured to burst the perforations between the lottery ticket being dispensed and the next lottery ticket of the strip so as to enable the dispensed lottery ticket to be dispensed into the ticket receptacle 250. This prevents a person from improperly tearing a lottery ticket or being able to pull an extended number of lottery tickets from one of the ticket packs in one of the ticket drawers. It should be appreciated that the ticket burster 400a can be moved to a dispensing location for each lottery ticket dispensed, or for only certain lottery tickets dispensed. It should also be appreciated that the ticket burster can moved to a different location for any lottery ticket that is deemed to be bad or non-dispensable for any reason, and to deposit that ticket into a suitable rejection area.

The ticket engagers 450a in this example embodiment include multiple driven rollers (not labeled) and multiple guide rollers (not labeled). The driven rollers are rotated by suitable actuators (not shown) under the control of the burster controller and/or the controller of the ticket vending machine 100. The driven rollers and the guide rollers are configured to move (such as by pulling) and guide each lottery ticket along the ticket movement path and out of the ticket outlet 424a. In alternative embodiments, the ticket engagers are configured to grip and pull each lottery ticket from the respective ticket drawer.

The burster controller (not shown) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) stores instructions executable by the processing device(s) to control operation of the ticket burster 400a. The burster controller can be hard wired or wirelessly connected to and in communication with the cutter 440a, the actuators for the driven rollers 450a, any actuators of the ticket burster 400a that cause the movement of the ticket burster 400a, and the reflective sensor 430a (as further described below). In such embodiments, the burster controller can be wirelessly connected to and in communication with the controller of the ticket vending machine 100. In other embodiments, the ticket burster does not include a controller and is completely controlled by the controller of the ticket vending machine 100. In such embodiments, the controller of the ticket vending machine 100 can be hard wired to or wirelessly connected to and in communication with the cutter, the actuators for the driven rollers, any actuators on the ticket burster or the burster supporter that cause the movement of the ticket burster, and the reflective sensor.

The example barcode reader 430a of the ticket burster 400a is positioned in and supported by the housing 402a of the ticket burster 400a. The barcode reader 430a extends transversely along the entire or substantially the entire width of the ticket burster 400a such that the barcode reader 430a can sense the one or more barcodes and the relative positions of the barcode(s) of each lottery ticket that moves through the ticket burster 400a as that lottery ticket moves above the barcode reader 430a. In this example embodiment, the barcode reader 430a is below the ticket movement path and thus scans upwardly toward the lottery ticket. In other alternative embodiments that are not shown, the barcode reader can be above the ticket movement path and thus scan downwardly toward the lottery ticket (which would be oriented to have the barcode facing upwardly).

The respective controller(s) receive and interpret the barcode related data and for brevity such process are not described in detail herein.

In various embodiments, the controller 500 includes a processor and a memory (not shown). The memory includes instructions that when executed by the processor cause and/or configure the processor to provide functionality as described herein. In various embodiments, the controller 500 includes a pre-positioning module (not shown) that is stored in the memory and includes the instructions. In other embodiments, all or a portion of the controller 500 can be implemented using application-specific integrated circuits or other suitable hardware.

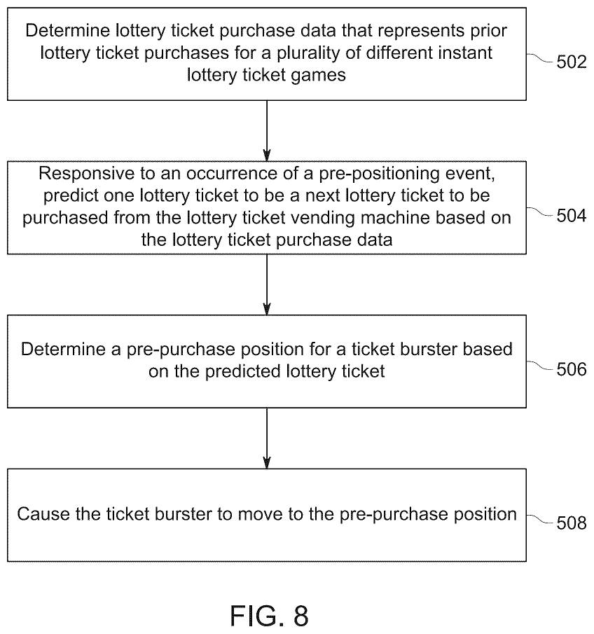

Turning to FIG. 8, an example method for pre-positioning a ticket burster of the lottery ticket vending machine 100 is now described. It should be appreciated that the following example is not the only method of operation of the ticket vending machine of the present disclosure, and other methods of operation are within the scope of the present disclosure. It should also be appreciated that the operations are controlled by the controller 500 of the ticket vending machine and/or the controller of the ticket bursters, and that the descriptions provided below of the steps are controlled by one or more of such controllers.

This example is before after a purchase of an instant lottery ticket and before a subsequent lottery ticket purchase from the lottery ticket vending machine 100. Responsive to an occurrence of a pre-positioning event (which can be a prior purchase of an instant lottery ticket from the lottery ticket vending machine 100 or another event such as described below), the controller 500 determines a pre-purchase position based on a predicted lottery ticket. The controller 500 causes the ticket burster to move to the pre-purchase position.

More specifically, the controller 500 determines lottery ticket purchase data that represents prior lottery ticket purchases for a plurality of different instant lottery ticket games, as shown at block 502. This lottery ticket purchase data can be for any suitable period of time. As an example, the prior lottery ticket purchases can include 40 purchases of instant lottery tickets from a first ticket drawer for a first game, 8 purchases of instant lottery tickets from a second ticket drawer for a second game, and 2 purchases of instant lottery tickets from a third drawer for a third game. In various embodiments, the controller 500 tracks ticket purchases made at the lottery ticket vending machine 100 and stores data and/or metadata for the ticket purchases as the lottery ticket purchase data within a memory of the controller 500. Examples of lottery ticket purchase data are further described below.

Responsive to an occurrence of a pre-positioning event, the controller 500 predicts one lottery ticket to be the subsequent lottery ticket to be purchased from the lottery ticket vending machine 100 based on the lottery ticket purchase data, as shown at block 504. In various embodiments, the controller 500 predicts the one lottery ticket based on an instant lottery ticket game having the highest quantity of prior lottery ticket purchases during a period of time (such as last 24 hours) and/or for a last quantity of lottery tickets purchased (such as last 100 purchases). Continuing with the example described above, the controller 500 predicts an instant lottery ticket for the first game will be the subsequent lottery ticket be purchased from the lottery ticket vending machine 100. This prediction is based on the 40 out of 50 the last purchases of lottery tickets during the period of time.

In various embodiments, examples of the pre-positioning event include: (1) completion of a prior lottery ticket purchase; (2) starting and/or modifying a new lottery ticket purchase (e.g., adding lottery tickets to a purchase); (3) startup of the lottery ticket vending machine 100; (4) receipt of a message from a lottery central server (not shown); (5) an occurrence of a pre-determined time (e.g., before a post-work rush or on a predetermined schedule); (6) according to timestamps associated with a beginning of a high volume of lottery ticket purchases; and (7) or other suitable events.

The controller 500 determines a pre-purchase position for a ticket burster based on the predicted lottery ticket, as shown at block 506. In various embodiments, the controller 500 determines the pre-purchase position as a ticket receipt position for a ticket drawer that holds the predicted lottery ticket. Using the example described above, the controller 500 determines the pre-purchase position as the ticket receipt position for the first ticket drawer.

The controller 500 causes the ticket burster to move to the pre-purchase position, as shown at block 508. Continuing with the example above, the controller 500 causes the ticket burster 400a to move to the ticket receipt position for the first ticket drawer. In the pre-purchase position, the ticket burster has a shorter distance to travel to the respective ticket drawer if the subsequent purchased lottery ticket is the predicted lottery ticket. In the example above, the distance to travel is effectively zero and the ticket burster 400a can immediately begin receiving, bursting, and dispensing that purchased lottery ticket. In addition to reducing a travel distance of the ticket burster 400a, moving the ticket burster 400a to the pre-purchase position reduces an amount of time during which a ticket purchaser must wait between purchasing a lottery ticket and being able to physically obtain the purchased lottery ticket from the ticket collection receptacle 250.

In various embodiments, the controller 500 determines the pre-purchase position to be a position other than a ticket receipt position for a ticket drawer. In some such embodiments, the controller 500 determines the pre-purchase position to be a position based on two or more ticket drawers, for example, two ticket drawers holding different instant lottery tickets that are frequently purchased. Using the example above, the controller 500 can determine the pre-purchase position based on the first ticket drawer (with 30 purchases) and the second ticket drawer (with 20 purchases). In one such example, the controller 500 determines the pre-purchase position as a midway point between the ticket receipt positions of the first and second ticket drawers. In another example, the controller 500 determines the pre-purchase position according to a distance ratio based on the quantity of ticket purchases from the ticket drawers (e.g., a pre-purchase position that is 40% of the distance from the first ticket drawer to the second ticket drawer).

In various embodiments, the controller 500 determines the pre-purchase position to actually or try to: (1) reduce a burster travel time of the ticket burster when dispensing a subsequent lottery ticket; (2) reduce a burster travel distance of the ticket burster when dispensing the subsequent lottery ticket; (3) reduce burster travel maintenance; (4) increase a service interval of the ticket burster and/or other components of the lottery ticket vending machine 100; (5) increase a service lifespan of the ticket burster and/or other components of the lottery ticket vending machine 100; and (6) reduce burster travel energy expenditure.

The burster travel time is a duration of time from when the ticket burster begins moving from its current position until the ticket burster reaches a ticket receipt position for a ticket drawer that holds the subsequent lottery ticket. Reductions in the burster travel time promote a reduction in wait time by a ticket purchaser while a purchased ticket is dispensed, which can improve a purchasing experience of the ticket purchaser and also improve a purchasing throughput of the lottery ticket vending machine.

In various embodiments, a travel speed of the ticket burster is faster in a first direction than in a second direction. In such embodiments, the controller 500 can determine the pre-purchase position based on the different travel speeds of the ticket burster in the different directions. In one such embodiment, the travel speed of the ticket burster can be faster in a down direction (e.g., due to assistance from gravity) than in an up direction. In another such embodiment, the travel speed of the ticket burster can be faster in a left and/or right direction than in an up and/or down direction, for example, due to different mechanical and/or electrical implementations of actuators for left/right movement and up/down movement of the ticket burster (e.g., a belt drive actuator, a screw drive actuator, electrical motors with different power output, different gearing or mechanical advantage, etc.).

The burster travel distance is a total distance from the current position of the ticket burster to the ticket receipt position. In various embodiments, the total distance can include a vertical distance, a horizontal distance, and/or both vertical and horizontal distances. In some scenarios, a reduction in the burster travel distance reduces wear of the actuators that move the ticket bursters.

The burster travel maintenance can include cleaning, lubrication, and/or replacement of components that control movement of the ticket burster, such as actuators, pulleys, drive belts, or other suitable components. In some scenarios, the controller 500 determines a pre-purchase position that prioritizes a reduction in maintenance for a particular actuator that has higher maintenance costs than other actuators.

The service interval of the ticket burster can include a period of time, a quantity of dispensed tickets, a total distance traveled, or other suitable interval at which burster travel maintenance can be performed. For example, burster travel maintenance can be performed every 60 days, after 3000 tickets have been dispensed, after a total distance of 4000 feet of travel (e.g., up and down to reach different ticket drawers), or other suitable intervals.

The burster travel energy expenditure can include electrical energy used to move the ticket burster to the ticket drawers.

With respect to the lottery ticket purchase data, each lottery ticket purchase can include a purchase of one, two, three, or more lottery tickets by a single purchaser. In other words, the lottery ticket purchase can include a deposit of money or credits by a purchaser into the lottery ticket vending machine 100, a selection of lottery ticket(s) by the purchaser, and dispensing of the selected lottery ticket(s) to the purchaser by the lottery ticket vending machine 100. The lottery ticket purchase data for a particular purchase can include one or more of: (1) a timestamp associated with the purchase (e.g., a time of day and date); (2) a game and/or game type(s) of the selected lottery ticket(s); (3) purchase parameters for the particular purchase (described below); (4) purchaser information (e.g., a user identifier or rewards card identifier); and/or (5) other suitable information.

The purchase parameters can include one or more of: (1) an amount (such as an amount of money) deposited by the purchaser into the ticket vending machine 100 for the purchase of instant lottery ticket(s); (2) an amount (such as an amount of money or price point) selected by the purchaser for the instant lottery ticket(s) from a greater amount (such as an amount of money) deposited by the purchaser into the ticket vending machine 100 (e.g., an amount for both instant lottery tickets and draw lottery tickets); (3) a quantity of instant lottery tickets for each game and/or game type; (4) a quantity of draw lottery tickets; (5) a quantity of instant lottery tickets; (6) a type of instant lottery game; (7) a new instant game or game type; and/or (9) one or more types of lottery tickets available to be purchased. It should be appreciated that the vending machine can have one or more input buttons such as via the user interface for the player to make inputs for such parameters.

In various embodiments, the controller 500 determines the lottery ticket purchase data for a particular time period. In certain such embodiments, the controller 500 tracks ticket purchases over an operational lifetime of the lottery ticket vending machine 100 to determine the lottery ticket purchase data. In certain such embodiments, the controller 500 tracks ticket purchases over a prior period (such as a day, a week, or a month) to determine the lottery ticket purchase data.

In various embodiments, the controller 500 determines a purchasing pattern for the lottery ticket purchases using the lottery ticket purchase data. In such embodiments, the controller 500 predicts the one lottery ticket to be the subsequent lottery ticket to be purchased from the lottery ticket vending machine 100 based on the purchasing pattern. In various embodiments, the lottery ticket purchase pattern is a pattern of individual lottery tickets purchased over time, for example, a first lottery ticket from a first ticket drawer, a second lottery ticket from the first ticket drawer, a third lottery ticket from a fifth ticket drawer, a fourth lottery ticket from a third ticket drawer, etc. In various embodiments, the lottery ticket purchase pattern is a pattern of individual ticket drawers from which instant lottery tickets are purchased.

In various embodiments, the lottery ticket purchase pattern includes a timestamp (e.g., time of day and date of purchase) associated with each ticket purchase. In various embodiments, the lottery ticket purchase data indicates times of higher probabilities of purchases of a particular instant lottery ticket game. In one example, the lottery ticket purchase pattern can indicate that tickets for a first lottery ticket game are most often sold on Friday and Saturday evenings and the controller 500 can determine, based on such lottery ticket purchase data, a pre-purchase position for the ticket burster that corresponds to a ticket drawer for the first lottery ticket game. In another example, the lottery ticket purchase pattern can indicate that tickets for a first lottery ticket game are holiday themed and associated with promotions for such tickets, and the controller 500 can determine, based on such lottery ticket purchase data, a pre-purchase position for the ticket burster that corresponds to a ticket drawer for the first lottery ticket game.

In various embodiments, the controller 500 updates the lottery ticket purchase data and/or the lottery ticket purchase pattern. In various embodiments, the controller 500 updates the lottery ticket purchase data and/or the lottery ticket purchase pattern after each ticket purchase. In various embodiments, the controller 500 updates the lottery ticket purchase data and/or the lottery ticket purchase pattern on a suitable time interval (such as daily, weekly, or monthly). In various embodiments, the controller 500 updates the lottery ticket purchase data and/or the lottery ticket purchase pattern responsive to a message received from a central lottery server (not shown).

In various embodiments, the pre-positioning module of the controller 500 includes a machine learning model and/or artificial intelligence (AI) model configured to: (1) predict the subsequent lottery ticket to be purchased from the lottery ticket vending machine 100; (2) determine a pre-purchase position from the lottery ticket purchase data; (3) determine a lottery ticket purchase pattern from the lottery ticket purchase data; and/or (4) determine a pre-purchase position from the lottery ticket purchase pattern.

In various embodiments, the pre-positioning module includes a machine learning model such as an autoregressive integrated moving average model, a regression analysis model, or other suitable model. In certain other embodiments, the pre-positioning module includes an artificial intelligence (AI) model such as a supervised learning model, an unsupervised learning model, or other suitable model.

In various embodiments, the AI model is trained using the lottery ticket purchase data. Once trained, the controller 500 provides inputs to the AI model and the AI model provides a predicted lottery ticket and/or a predicted lottery ticket drawer as an output.

In various embodiments, the controller 500 determines a statistical model based on the lottery ticket purchase data. In such embodiments, the controller 500 predicts the one lottery ticket to be the subsequent lottery ticket to be purchased based on the statistical model. In various embodiments, the statistical model is a reference table according to a current time. In various such embodiments, the controller 500, responsive to the occurrence of the pre-positioning event, performs a table lookup with a current timestamp to predict the subsequent lottery ticket to be purchased.

In various embodiments, the controller 500 stores lottery ticket purchase data that is aggregated from one or a plurality of external sources (not shown). In various embodiments, the external sources include other lottery ticket vending machines, lottery central servers, lottery terminals, or other suitable sources. In various embodiments, each of a plurality of external sources independently tracks or obtains lottery ticket purchase data for lottery tickets and the controller 500 receives the lottery ticket purchase data from the external sources. In various embodiments, the controller 500 sends lottery ticket purchase data tracked and stored by the lottery ticket vending machine 100 to a lottery central server (not shown) or to another lottery ticket vending machine.

Although the process for pre-positioning the ticket burster described above is for a single ticket burster, in various embodiments, the controller 500 performs one or more steps of the process for multiple ticket bursters. In various embodiments, the controller 500 performs each step of the process for each ticket burster of the lottery ticket vending machine 100. In other words, the controller 500 performs three independent instances of the process with one instance for each of the three ticket burster 400a, 400b, and 400c. In various such embodiments, the controller 500 determines the lottery ticket purchase data separately for each ticket burster (i.e., first lottery ticket purchase data for the ticket burster 400a, second lottery ticket purchase data for the ticket burster 400b, and third lottery ticket purchase data for the ticket burster 400c). This can be based on the respective lottery tickets in the respective ticket drawers associated with each ticket burster.

In various embodiments, the controller 500 determines the lottery ticket purchase data for all lottery ticket purchases of the lottery ticket vending machine 100 (e.g., tracking purchases for all of the ticket drawers) and performs the prediction (block 504), the pre-purchase position determination (block 506), and the movement of the ticket burster (block 508) independently for each ticket burster.

In various embodiments, the controller 500 predicts a lottery ticket to be a subsequent lottery ticket to be purchased for each ticket burster of the lottery ticket vending machine 100. In other words, the controller 500 makes multiple predictions of subsequent lottery tickets to be purchased with one prediction for each ticket burster. In some such embodiments, the controller 500 performs each of the predictions responsive to a same pre-positioning event, determines the pre-purchase positions associated with each predicted lottery ticket, and causes the ticket bursters to move to the pre-purchase positions. In various embodiments, the controller 500 moves each of the ticket bursters at block 508 simultaneously. In various embodiments, the controller 500 moves the ticket bursters at block 508 sequentially (i.e., first moving the ticket burster 400a, then moving the ticket burster 400b, etc.).

In various embodiments, the controller 500 performs the predictions of the subsequent lottery ticket to be purchased for multiple ticket bursters responsive to different pre-positioning events. For example, the ticket burster 400a can be associated with a first pre-positioning event, the ticket burster 400b can be associated with a second pre-positioning event, etc.

In various embodiments, the controller 500 reuses all or a portion of the lottery ticket purchase data. In other words, the controller 500 performs additional iterations of the process for pre-positioning the ticket burster, responsive to subsequent occurrences of the pre-positioning event, using the same lottery ticket purchase data. In some scenarios, the controller omits the determination of the lottery ticket purchase data at block 502 and instead reuses lottery ticket purchase data that was previously determined in a prior iteration.

In various other embodiments, the controller 500 performs one or more of the predictions of the subsequent lottery ticket(s) to be purchased based on one or more lottery tickets that have been selected to be in an electronic shopping cart before a check-out (including a payment) for that electronic shopping cart. For example, the lottery ticket vending machine can enable a purchaser to select, via a user interface of the lottery ticket vending machine, one or more lottery tickets to place into an electronic shopping cart displayed or otherwise provided by the lottery ticket vending machine. When one or more lottery tickets are placed in that electronic shopping cart, the controller of the vending machine can determine whether any pre-positioning movements of one or more of the bursters should be made based on that lottery ticket data. Thus, the lottery tickets in the shopping cart can function as lottery ticket purchase data that can be used for pre-positioning one or more of the ticket bursters. In various embodiments, a remote electronic device can provide the electronic shopping cart that the vending machine can access to obtain such data.

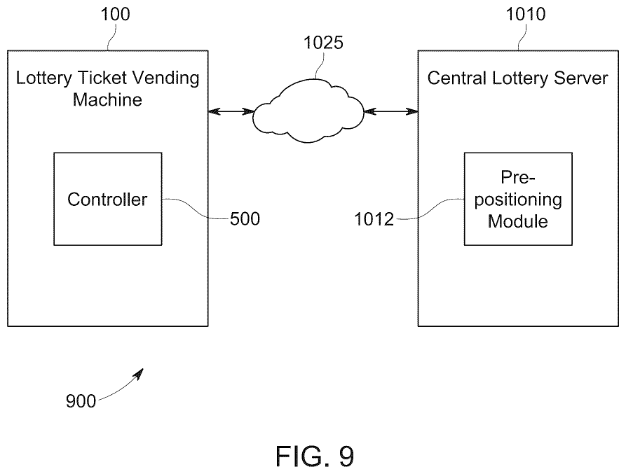

Turning to FIG. 9, a system 900 for providing pre-positioning according to an alternative embodiment is shown. The system 900 includes the lottery ticket vending machine 100 and a central lottery server 1010 that are communicatively connected via a network 1025.

In various embodiments, the central lottery server 1010 includes a processor and a memory (not shown). The memory includes instructions that when executed by the processor cause and/or configure the processor to provide various functionality as described herein. In various embodiments, the central lottery server 1010 includes one or more modules, such as a pre-positioning module 1012, that are stored in the memory and includes the instructions. In other embodiments, all or a portion of the central lottery server 1010 can be implemented using application-specific integrated circuits or other suitable hardware. In various embodiments, the central lottery server 1010 includes one or more other modules (not shown) that enable functionality such as activation of instant lottery tickets, processing of draw game wager requests for draw lottery tickets, processing of ticket redemption requests for lottery tickets, and other lottery ticket related functionality. It should be appreciated that the central lottery server 1010 includes various other electronic components that are conventional in the industry and/or that would be readily apparent to those of ordinary skill in the art. The electronic components can include one or more controllers that control the operation of the central lottery server 1010 to facilitate operation of the lottery ticket vending machine 1000. The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the central lottery server 1010.

The network 1025 enables communication between the lottery ticket vending machine 100 and the central lottery server 1010. In the embodiment shown in FIG. 9, the network 1025 is a private network that is secured from unauthorized access.

In the embodiment shown in FIG. 9, the central lottery server 1010 performs at least a portion of the steps for pre-positioning the ticket burster of the lottery ticket vending machine 100. More specifically, the pre-positioning module 1012 of the central lottery server 1010 provides at least some of the functionality described above with respect to the pre-positioning module of the controller 500. In the embodiment shown in FIG. 9, the central lottery server 1010 receives and stores lottery ticket purchase data from the lottery ticket vending machine 100 and the pre-positioning module 1012 is configured to predict the one lottery ticket to be the subsequent lottery ticket to be purchased from the lottery ticket vending machine 100 based on the lottery ticket purchase data, as described above. In this embodiment, the pre-positioning module 1012 acts to offload processor intensive tasks from the lottery ticket vending machine 100, for example, to improve processing speed of the subsequent lottery ticket prediction.

In various embodiments, the central lottery server 1010, via the pre-positioning module 1012, determines a purchasing pattern for the lottery ticket purchases using the lottery ticket purchase data. In various such embodiments, the central lottery server 1010 sends the purchasing pattern to the lottery ticket vending machine 100. That is, the central lottery server 1010 determines the purchasing pattern for the lottery ticket vending machine 100, which can then use the purchasing pattern received from the central lottery server 1010 to predict the subsequent lottery ticket as described above.

In various embodiments, the pre-positioning module 1012 determines the purchasing pattern and also predicts the one lottery ticket to be the subsequent lottery ticket to be purchased from the lottery ticket vending machine 100. The central lottery server 1010 then sends a message indicating the predicted lottery ticket to the lottery ticket vending machine 100, from which the lottery ticket vending machine can determine the pre-purchase position.

In various embodiments, the pre-positioning module 1012 determines the purchasing pattern, predicts the one lottery ticket to be the subsequent lottery ticket to be purchased from the lottery ticket vending machine 100, and determines the pre-purchase position. The central lottery server 1010 then sends a message indicating the pre-purchase position to the lottery ticket vending machine 100.

In various embodiments, the pre-positioning module 1012 includes a machine learning model and/or artificial intelligence model configured to: (1) predict the subsequent lottery ticket to be purchased from the lottery ticket vending machine 100; (2) determine a pre-purchase position from the lottery ticket purchase data; (3) determine a lottery ticket purchase pattern from the lottery ticket purchase data; and/or (4) determine a pre-purchase position from the lottery ticket purchase pattern. For example, the AI model of the controller 500 can be supplemented by, or replaced with, an AI model of the pre-positioning module 1012. In various such embodiments, the pre-positioning module 1012 is configured to train the AI model using the lottery ticket purchase data and provide the trained model (or parameters corresponding to the trained model) to the controller 500. In these embodiments, the pre-positioning module 1012 offloads the processor intensive task of training the AI model from the lottery ticket vending machine 100.

In various embodiments, the central lottery server 1010 receives lottery ticket purchase data from a plurality of lottery ticket vending machines, such as the lottery ticket vending machine 100. The central lottery server 1010 aggregates the received lottery ticket purchase data and determines any purchase patterns from the aggregated data. In various such embodiments, the central lottery server 1010 enables the determination of a pre-purchase position based on lottery ticket purchase data from multiple lottery ticket vending machines. In various embodiments, the central lottery server 1010 selects a subset of the aggregated lottery ticket purchase data to determine a purchase pattern, predict a subsequent lottery ticket, and/or determine a pre-purchase position. For example, the central lottery server 1010 can select a subset of the aggregated lottery ticket purchase data according to a particular store in which a group of lottery ticket vending machines are located, a particular geographical region in which a group of lottery ticket vending machines are located, or other suitable subset having related purchasing data.

It should be appreciated from the above that various embodiments of the present disclosure provide a lottery ticket vending machine comprising: (1) a housing; (2) a ticket drawer holder in the housing, the ticket drawer holder comprising a plurality of ticket drawers, each of the ticket drawers configured to hold a pack of instant lottery tickets for one of a plurality of different instant lottery ticket games; (3) a ticket receptacle supported by the housing; (4) a ticket burster in the housing, the ticket burster movable to a plurality of different ticket receipt positions, each different ticket receipt position associated with and in alignment with a different one of the plurality of ticket drawers, wherein in each ticket receipt position the ticket burster is configured to receive from the ticket drawer associated with that ticket receipt position an instant lottery ticket attached to a next instant lottery ticket, separate the instant lottery ticket from the next instant lottery ticket, and dispense the instant lottery ticket into the ticket receptacle; and (5) a controller comprising a processor and memory device that stores a plurality of instructions, which when executed by the processor cause the processor to: (a) determine lottery ticket purchase data that associated with prior lottery ticket purchases for the plurality of different instant lottery ticket games; (b) responsive to an occurrence of a pre-positioning event, predict one of the lottery tickets in one of the ticket drawers to be a subsequent lottery ticket to be purchased from the lottery ticket vending machine based on the lottery ticket purchase data; (c) determine a pre-purchase position for the ticket burster based on the predicted lottery ticket and the ticket drawer that the predicted lottery ticket is held; and (d) cause the ticket burster to move to the pre-purchase position. In various such embodiments, the pre-purchase position is a position aligned with the one of the ticket drawers that holds the predicted one of the lottery tickets to be the subsequent lottery ticket to be purchased from the lottery ticket vending machine. In various such embodiments, the pre-purchase position is a position adjacent to the one of the ticket drawers that holds the predicted one of the lottery tickets to be the subsequent lottery ticket to be purchased from the lottery ticket vending machine. In various such embodiments, the pre-purchase position is a position between two of the ticket drawers, wherein one of the two ticket drawers is the one of the ticket drawers that holds the predicted one of the lottery tickets to be the subsequent lottery ticket to be purchased from the lottery ticket vending machine. In various such embodiments, the lottery ticket purchase data comprises data created by the processor. In various such embodiments, the lottery ticket purchase data comprises data received from a central lottery system. In various such embodiments, the lottery ticket purchase data comprises data received from another lottery ticket vending machine. In various such embodiments, the lottery ticket purchase data is based on a period of time of previous purchases of instant lottery tickets for the plurality of different instant lottery ticket games. In various such embodiments, the lottery ticket purchase data is based on a period of time of previous purchases of instant lottery tickets for the plurality of different instant lottery ticket games. In various such embodiments, the lottery ticket purchase data is based on a period of time of previous purchases of instant lottery tickets for the plurality of different instant lottery ticket games in a geographic area where the lottery ticket vending machine is located. In various such embodiments, the lottery ticket purchase data is based on a pre-determined total quantity of previous purchases of instant lottery tickets for the plurality of different instant lottery ticket games. In various such embodiments, the lottery ticket purchase data is based on a pre-determined total quantity of previous purchases of instant lottery tickets for the plurality of different instant lottery ticket games in a geographic area where the lottery ticket vending machine is located.

It should be further appreciated from the above that various embodiments of the present disclosure provide a lottery ticket vending machine comprising: (1) a housing; (2) a plurality of ticket drawers in the housing, each of the ticket drawers configured to hold a pack of instant lottery tickets for one of a plurality of different instant lottery ticket games; (3) a ticket burster the housing, the ticket burster movable to a plurality of different ticket receipt positions, each different ticket receipt position associated with and in alignment with a different one of the plurality of ticket drawers; and (4) a controller comprising a processor and memory device that stores a plurality of instructions, which when executed by the processor cause the processor to: (a) determine a pre-purchase position for the ticket burster based on a predicted one of the instant lottery tickets for a subsequent purchase from the lottery ticket vending machine and the ticket drawer that the predicted one of instant lottery tickets is held, and (b) cause the ticket burster to move to the pre-purchase position. In various such embodiments, the plurality of instructions, when executed by the processor, cause the processor use lottery ticket purchase data to determine the predicted one of the instant lottery tickets. In various such embodiments, the plurality of instructions, when executed by the processor, cause the processor use lottery ticket purchase data created by the lottery ticket vending machine to determine the predicted one of the instant lottery tickets. In various such embodiments, the plurality of instructions, when executed by the processor, cause the processor to use lottery ticket purchase data received from a central lottery system to determine the predicted one of the instant lottery tickets. In various such embodiments, the plurality of instructions, when executed by the processor, cause the processor to use data received from a central lottery system to determine the predicted one of the instant lottery tickets.

It should be further appreciated from the above that various embodiments of the present disclosure provide a lottery ticket vending machine comprising: (1) a housing; (2) a first plurality of ticket drawers in the housing, each of the first ticket drawers configured to hold a pack of instant lottery tickets for one of a first plurality of different instant lottery ticket games; (3) a second plurality of ticket drawers in the housing, each of the second ticket drawers configured to hold a pack of instant lottery tickets for one of a second plurality of different instant lottery ticket games; (4) a first ticket burster in the housing, the first ticket burster movable to a first plurality of different ticket receipt positions, each different ticket receipt position associated with and in alignment with a different one of the first plurality of ticket drawers; (5) a second ticket burster in the housing, the second ticket burster movable to a second plurality of different ticket receipt positions, each different ticket receipt position associated with and in alignment with a different one of the second plurality of ticket drawers; and (6) a controller comprising a processor and memory device that stores a plurality of instructions, which when executed by the processor cause the processor to: (a) determine a first pre-purchase position for the first ticket burster based on a first predicted one of the instant lottery tickets for a subsequent purchase from the lottery ticket vending machine and the ticket drawer of the first plurality of ticket drawers that the first predicted one of instant lottery tickets is held, (b) cause the first ticket burster to move to the first pre-purchase position, (c) determine a second pre-purchase position for the second ticket burster based on a second predicted one of the instant lottery tickets for a subsequent purchase from the lottery ticket vending machine and the ticket drawer of the second plurality of ticket drawers that the second predicted one of instant lottery tickets is held, and (d) cause the second ticket burster to move to the second pre-purchase position. In various such embodiments, the plurality of instructions, when executed by the processor, cause the processor use lottery ticket purchase data to determine the first predicted one of the instant lottery tickets and the second predicted one of the instant lottery tickets. In various such embodiments, the plurality of instructions, when executed by the processor, cause the processor use lottery ticket purchase data created by the lottery ticket vending machine to determine the first predicted one of the instant lottery tickets and the second predicted one of the instant lottery tickets.

It should also be appreciated that the ticket burster pre-positioning feature can be employed in other suitable lottery ticket vending machines, which can include different components and/or operate in different suitable manners.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket vending machine comprising:
a housing;
a ticket drawer holder in the housing, the ticket drawer holder comprising a plurality of ticket drawers, each of the ticket drawers configured to hold a pack of instant lottery tickets for one of a plurality of different instant lottery ticket games;
a ticket receptacle supported by the housing;
a ticket burster in the housing, the ticket burster movable to a plurality of different ticket receipt positions, each different ticket receipt position associated with and in alignment with a different one of the plurality of ticket drawers, wherein in each ticket receipt position the ticket burster is configured to receive from the ticket drawer associated with that ticket receipt position an instant lottery ticket attached to a next instant lottery ticket, separate the instant lottery ticket from the next instant lottery ticket, and dispense the instant lottery ticket into the ticket receptacle; and
a controller comprising a processor and memory device that stores a plurality of instructions, which when executed by the processor cause the processor to:
determine lottery ticket purchase data that associated with prior lottery ticket purchases for the plurality of different instant lottery ticket games;
responsive to an occurrence of a pre-positioning event, predict one of the lottery tickets in one of the ticket drawers to be a subsequent lottery ticket to be purchased from the lottery ticket vending machine based on the lottery ticket purchase data;
determine a pre-purchase position for the ticket burster based on the predicted lottery ticket and the ticket drawer that the predicted lottery ticket is held; and
cause the ticket burster to move to the pre-purchase position.

2. The lottery ticket vending machine of claim 1, wherein the pre-purchase position is a position aligned with the one of the ticket drawers that holds the predicted one of the lottery tickets to be the subsequent lottery ticket to be purchased from the lottery ticket vending machine.

3. The lottery ticket vending machine of claim 1, wherein the pre-purchase position is a position adjacent to the one of the ticket drawers that holds the predicted one of the lottery tickets to be the subsequent lottery ticket to be purchased from the lottery ticket vending machine.

4. The lottery ticket vending machine of claim 1, wherein the pre-purchase position is a position between two of the ticket drawers, wherein one of the two ticket drawers is the one of the ticket drawers that holds the predicted one of the lottery tickets to be the subsequent lottery ticket to be purchased from the lottery ticket vending machine.

5. The lottery ticket vending machine of claim 1, wherein the lottery ticket purchase data comprises data created by the processor.

6. The lottery ticket vending machine of claim 1, wherein the lottery ticket purchase data comprises data received from a central lottery system.

7. The lottery ticket vending machine of claim 1, wherein the lottery ticket purchase data comprises data received from another lottery ticket vending machine.

8. The lottery ticket vending machine of claim 1, wherein the lottery ticket purchase data is based on a period of time of previous purchases of instant lottery tickets for the plurality of different instant lottery ticket games.

9. The lottery ticket vending machine of claim 1, wherein the lottery ticket purchase data is based on a period of time of previous purchases of instant lottery tickets for the plurality of different instant lottery ticket games.

10. The lottery ticket vending machine of claim 1, wherein the lottery ticket purchase data is based on a period of time of previous purchases of instant lottery tickets for the plurality of different instant lottery ticket games in a geographic area where the lottery ticket vending machine is located.

11. The lottery ticket vending machine of claim 1, wherein the lottery ticket purchase data is based on a pre-determined total quantity of previous purchases of instant lottery tickets for the plurality of different instant lottery ticket games.

12. The lottery ticket vending machine of claim 1, wherein the lottery ticket purchase data is based on a pre-determined total quantity of previous purchases of instant lottery tickets for the plurality of different instant lottery ticket games in a geographic area where the lottery ticket vending machine is located.

13. A lottery ticket vending machine comprising:
a housing;
a plurality of ticket drawers in the housing, each of the ticket drawers configured to hold a pack of instant lottery tickets for one of a plurality of different instant lottery ticket games;
a ticket burster the housing, the ticket burster movable to a plurality of different ticket receipt positions, each different ticket receipt position associated with and in alignment with a different one of the plurality of ticket drawers; and
a controller comprising a processor and memory device that stores a plurality of instructions, which when executed by the processor cause the processor to:
determine a pre-purchase position for the ticket burster based on a predicted one of the instant lottery tickets for a subsequent purchase from the lottery ticket vending machine and the ticket drawer that the predicted one of instant lottery tickets is held, and
cause the ticket burster to move to the pre-purchase position.

14. The lottery ticket vending machine of claim 13, wherein the plurality of instructions, when executed by the processor, cause the processor use lottery ticket purchase data to determine the predicted one of the instant lottery tickets.

15. The lottery ticket vending machine of claim 13, wherein the plurality of instructions, when executed by the processor, cause the processor use lottery ticket purchase data created by the lottery ticket vending machine to determine the predicted one of the instant lottery tickets.

16. The lottery ticket vending machine of claim 13, wherein the plurality of instructions, when executed by the processor, cause the processor to use lottery ticket purchase data received from a central lottery system to determine the predicted one of the instant lottery tickets.

17. The lottery ticket vending machine of claim 13, wherein the plurality of instructions, when executed by the processor, cause the processor to use data received from a central lottery system to determine the predicted one of the instant lottery tickets.

18. A lottery ticket vending machine comprising:
a housing;
a first plurality of ticket drawers in the housing, each of the first ticket drawers configured to hold a pack of instant lottery tickets for one of a first plurality of different instant lottery ticket games;
a second plurality of ticket drawers in the housing, each of the second ticket drawers configured to hold a pack of instant lottery tickets for one of a second plurality of different instant lottery ticket games;
a first ticket burster in the housing, the first ticket burster movable to a first plurality of different ticket receipt positions, each different ticket receipt position associated with and in alignment with a different one of the first plurality of ticket drawers;
a second ticket burster in the housing, the second ticket burster movable to a second plurality of different ticket receipt positions, each different ticket receipt position associated with and in alignment with a different one of the second plurality of ticket drawers; and
a controller comprising a processor and memory device that stores a plurality of instructions, which when executed by the processor cause the processor to:
determine a first pre-purchase position for the first ticket burster based on a first predicted one of the instant lottery tickets for a subsequent purchase from the lottery ticket vending machine and the ticket drawer of the first plurality of ticket drawers that the first predicted one of instant lottery tickets is held,
cause the first ticket burster to move to the first pre-purchase position,
determine a second pre-purchase position for the second ticket burster based on a second predicted one of the instant lottery tickets for a subsequent purchase from the lottery ticket vending machine and the ticket drawer of the second plurality of ticket drawers that the second predicted one of instant lottery tickets is held, and
cause the second ticket burster to move to the second pre-purchase position.

19. The lottery ticket vending machine of claim 18, wherein the plurality of instructions, when executed by the processor, cause the processor use lottery ticket purchase data to determine the first predicted one of the instant lottery tickets and the second predicted one of the instant lottery tickets.

20. The lottery ticket vending machine of claim 18, wherein the plurality of instructions, when executed by the processor, cause the processor use lottery ticket purchase data created by the lottery ticket vending machine to determine the first predicted one of the instant lottery tickets and the second predicted one of the instant lottery tickets.
